(19) United States
(12) Patent Application Publication
(10) Pub. No.: US 2009/0284954 A1
(43) Pub. Date: Nov. 19, 2009

(54) BACKLIGHT DEVICE, DISPLAY DEVICE, AND OPTICAL MEMBER

(76) Inventors: Yukinori Yamada, Osaka (JP); Masataka Sato, Osaka (JP)

Correspondence Address: BIRCH STEWART KOLASCH & BIRCH, PO BOX 747, FALLS CHURCH, VA, 22040-0747, US

(21) Appl. No.: 12/067,027

(22) PCT Filed: Oct. 20, 2006
(86) PCT No.: PCT/JP2006/320930

§ 371 Date: Mar. 14, 2008

(30) Foreign Application Priority Data
Oct. 28, 2005 (JP) 2005 315144

(51) Int. Cl. F21V 5/04; G02B 27/12

(52) U.S. Cl. 362/97.2; 362/97.1; 359/623; 359/624

(57) ABSTRACT

A backlight device 10 according to the invention includes an optical member 17 provided on a surface light source. The optical member 17 includes a lenticular lens sheet 14 having a plurality of cylindrical lenses CL1 arranged in parallel to one another and a lenticular lens sheet 15 provided on the lenticular lens sheet 14 and having a plurality of cylindrical lenses CL2 arranged in parallel to one another. Therefore, light emitted obliquely to the front surface can be restrained and improved front side brightness is provided.

### TECHNICAL FIELD

The present invention relates to a backlight device, a display device, and an optical member, and more specifically, to a backlight device for use in a display device, a display device having a backlight device and an optical member for use in a backlight device.

### BACKGROUND ART

In the field of display devices such as a liquid crystal display, there is a demand for improved front side brightness. Therefore, in a backlight device for use in such a display, an optical member used to control the angular distribution of brightness and improve the front side brightness is provided. As disclosed by JP 3262230 B (Patent Document 1), a prism sheet is generally used as such an optical member.

As shown in FIG. 20, the prism sheet 100 has a plurality of prisms PL arranged. Diffused light R0 from a surface light source is refracted at the side plane BP0 of a prism PL and emitted as it is deflected to the front surface direction. In this way, the prism sheet 100 improves the front side brightness of the display by deflecting the diffused light to the front surface direction.

However, the prism sheet 100 can improve the front side brightness while it also raises the brightness in the front side oblique direction. The solid line in FIG. 21 shows the angular distribution of brightness of the vertical viewing angle of the prism sheet 100 having the prisms PL arranged in the vertical direction (that corresponds to the vertical direction of the display screen). With reference to FIG. 21, the relative brightness is raised for vertical viewing angles in the range of ±30°, while side lobes whose relative brightness values peak around viewing angles of 80° and −80° are generated. The angular distribution of brightness shown by the solid line in FIG. 21 takes an unnatural curve unlike a natural angular distribution of brightness that peaks at a viewing angle of 0° with the brightness being gradually lowered as the viewing angle widens, and the user might have unnatural impressions in some cases. Therefore, light that forms the side lobes (hereinafter referred to as “side lobe light”) should be kept from being emitted so that the side lobes can be restrained.

According to the disclosure of JP 10-506500 A (Patent Document 2), the distance between adjacent prisms (prism pitch) is reduced, so that the side lobe light can be reduced, but the unnaturalness of the angular distribution of brightness is still unsolved.

Furthermore, a prism PL has a triangular cross section and therefore can easily be damaged during its manufacture, transport and installment to a backlight device, particularly at its apex. Such a defect is likely to result in a bright point or a dark point on the display. In order to prevent such defects, the prism sheet 100 before being installed into a display device must be provided with a protection film.
[Patent Document 1] JP 3262230 B
[Patent Document 2] JP 10-506500 A

### DISCLOSURE OF THE INVENTION

It is an object of the present invention to provide a backlight device that prevents side lobe light from being emitted obliquely to the front surface and has high front side brightness.

Another object of the invention is to provide a backlight device with an optical member free of a protection film.

Yet another object of the invention is to provide a backlight device capable of adjusting the angular distribution of brightness in two axial directions.

A backlight device according to the invention includes a surface light source, and first and second lenticular lens sheets. The first lenticular lens sheet is provided on the surface light source and includes a plurality of first cylindrical lenses arranged. The second lenticular lens sheet is provided on the first lenticular lens sheet and includes a plurality of second cylindrical lenses arranged.

The backlight device according to the invention has a lenticular lens sheet provided instead of a conventional prism sheet. With the prism, light totally reflected at an inside surface of the prism is transmitted through another inside surface to be side lobe light, while with the cylindrical lens, light totally reflected at an inside surface is again totally reflected at another inside surface, so that side lobe light is less easily emitted. Therefore, the use of the lenticular lens sheet can restrain side lobes from being generated.

Furthermore, a plurality of lenticular lens sheets are placed on one another, so that outgoing light can be collected in the front surface direction. Therefore, the front side brightness can be improved as compared to a single prism sheet.

Since the convex surface of a cylindrical lens has a curvature and therefore is less easily damaged during the manufacture unlike the prism lens. This eliminates the necessity of a protection film.

A direction in which the first cylindrical lenses are arranged preferably crosses a direction in which the second cylindrical lenses are arranged, and more preferably, the first cylindrical lenses are orthogonal to the second cylindrical lenses.

In this way, the two lenticular lens sheets collect light in two axial directions with respect to the surface light source, so that the front side brightness is more improved. Note that the directions in which the first and second cylindrical lenses are arranged do not have to be strictly orthogonal to each other and need only cross in the range that allows light to be collected in two axial directions.

Preferably, a first angle formed by the convex surface of the first cylindrical lens and a plane including both edges of the first cylindrical lens is different from a second angle formed by the convex surface of the second cylindrical lens and a plane including both edges of the second cylindrical lens.

In this way, the angular distribution of brightness can be adjusted to be different between the two axial directions. Therefore, for example, the viewing angles in the vertical and horizontal directions can be set to different ranges.

The first angle is preferably greater than the second angle.

In this way, the angular distribution of brightness in the arrangement direction of the second cylindrical lenses can be wider than the arrangement direction of the first cylindrical lenses. Therefore, for example, the horizontal viewing angle can be wider than the vertical viewing angle.

Furthermore, if the angle formed by the convex surface of the cylindrical lens and the plane including both edges is large, side lobe light is more easily generated, while by placing the second cylindrical lenses with the second angle smaller than the first angle on the first cylindrical lenses, side lobe light generated at the first cylindrical lenses can be restrained from being emitted to the outside.

The first angle is preferably in the range from 60° to 90°.

In this way, light can be more effectively collected.

Preferably, at least one of the first and second lenticular lens sheets has a gap between the cylindrical lenses arranged.

When the angle formed by the convex surface and the plane including the edges is close to 90°, it is difficult to produce the cylindrical lenses adjacent to one another. A cylindrical lens that allows the angle formed by the convex surface and the plane including the edges to be larger can be more easily produced by providing the gap between the cylindrical lenses.

Preferably, the first and second lenticular lens sheets are rectangular. The first cylindrical lenses are arranged along the shorter side of the first lenticular lens sheet. The second cylindrical lenses are arranged along the longer side of the second lenticular lens sheet.

In general, a display device is elongated in the horizontal direction. Therefore, in the above-described structure, the vertical viewing angle is adjusted by the first lenticular lens sheet and the horizontal viewing angle is adjusted by the second lenticular lens sheet. Therefore, the horizontal viewing angle can be set wider than the vertical viewing angle. Note that the “rectangular shape” herein does not have to be a strict rectangular shape and any rectangular shape having longer and shorter sides can be employed.

A display device according to the invention includes the backlight device described above. Preferably, the display device includes a liquid crystal panel on the above-described backlight device. The optical member according to the invention includes first and second lenticular lens sheets for use in the above-described backlight device.

### BRIEF DESCRIPTION OF THE DRAWINGS

FIG. 1 is a perspective view of a display device including a backlight device according to an embodiment of the invention;

FIG. 2 is a sectional view taken along line II-II in FIG. 1;

FIG. 3 is a sectional view of the optical member shown in FIG. 2;

FIG. 4 is a perspective view of the optical member shown in FIG. 2;

FIG. 5A is a schematic view for use in illustrating the principle of how side lobe light is reduced by a cylindrical lens;

FIG. 5B is another schematic view different from FIG. 5A for use in illustrating the principle of how side lobe light is reduced by a cylindrical lens;

FIG. 6A is a schematic view for use in illustrating the relation between the contact angle between the convex surface of a cylindrical lens and the edge plane and the outgoing direction of light;

FIG. 6B is another schematic view different from FIG. 6A for use in illustrating the relation between the contact angle between the convex surface of a cylindrical lens and the edge plane and the outgoing direction of light;

FIG. 7 is a sectional view of another optical member in a different shape from the optical member shown in FIG. 2;

FIG. 8 is a sectional view of another optical member in a different shape from the optical members shown in FIGS. 2 and 7;

FIG. 9 is a perspective view of another optical member having a layered structure different from the layered structure of the optical member shown in FIG. 4;

FIG. 10 is a view showing the shape and size of an optical member used according to a first embodiment;

FIG. 11 shows the angular distribution of brightness obtained according to the first embodiment;

FIG. 12 is a view showing the shape and size of an optical member used according to a second embodiment;

FIG. 13 shows the angular distribution of brightness obtained according to the second embodiment;

FIG. 14 is a view showing the shape and size of an optical member used according to a third embodiment;

FIG. 15 is the angular distribution of brightness produced according to the third embodiment;

FIG. 16 is a view showing the shape and size of an optical member used according to a fourth embodiment;

FIG. 17 shows the angular distribution of brightness obtained according to the fourth embodiment;

FIG. 18 is a view showing the shape and size of an optical member used according to a fifth embodiment;

FIG. 19 shows the angular distribution of brightness obtained according to the fifth embodiment;

FIG. 20 is a cross sectional view of a conventional prism sheet; and

FIG. 21 shows the angular distribution of brightness obtained using the conventional prism sheet.

### BEST MODE FOR CARRYING OUT THE INVENTION

Embodiments of the present invention will be described in detail in conjunction with the drawings in which the same or corresponding portions are denoted by the same reference characters and their description will not be repeated.

General Structure

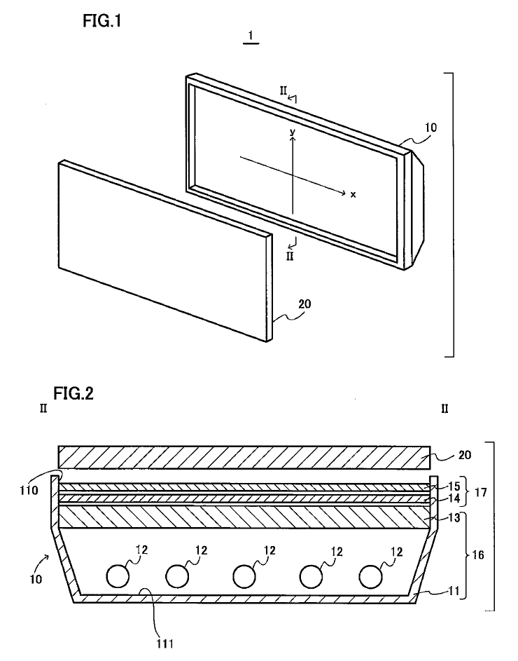

With reference to FIGS. 1 and 2, a display device 1 includes a backlight device 10 and a liquid crystal panel 20 provided at the front surface of the backlight device 10. The front surface of the display device 1 is in a rectangular shape that has the longer sides in the horizontal direction (x direction in the figures) and the shorter sides in the vertical direction (y direction in the figures).

The backlight device 10 includes a surface light source 16 that emits diffused light and an optical member 17 provided on the surface light source 16.

Surface Light Source

The surface light source 16 includes a housing 11, a plurality of cold cathode fluorescent lamps 12 and a light diffuser plate 13. The housing 11 is a case having an opening 110 at the front and stores the cold cathode fluorescent lamps 12 inside. The inside surface of the housing 11 is covered with an anti-reflection film 111. The anti-reflection film 111 diffusely reflects light emitted from the cold cathode fluorescent lamps 12 and guides the light to the opening 110. The anti-reflection film 111 may be for example Lumirror® E60L or E60V manufactured by Toray Industries, Inc. and preferably has a diffuse reflectance of 95% or more.

The plurality of cold cathode fluorescent lamps 12 are arranged in parallel in the vertical direction (y-direction in FIG. 1) in front of the back surface of the housing 11. The cold cathode fluorescent lamps 12 are so called line light sources such as a fluorescent tube that extend in the horizontal direction (x-direction in FIG. 1). Note that a plurality of point light sources such as an LED (Light Emitting Device) may be stored in the housing 11 instead of the cold cathode fluorescent lamps 12.

The light diffuser plate 13 is fitted into the opening 110 and provided in parallel to the back surface of the housing 11. The light diffuser plate 13 is fitted into the opening 110 so that the inside of the housing 11 is enclosed, and light from the cold cathode fluorescent lamps 12 can be prevented from being emitted to the outside of the housing 11 from any part other than from the light diffuser plate 13, which can improve the light use efficiency.

The light diffuser plate 13 diffuses light from the cold cathode fluorescent lamps 12 and light reflected by the anti-reflection film 111 and emits the light to the front surface. The light diffuser plate 13 includes a transparent base material and a plurality of particles dispersed in the base material. The refractive index of the particles dispersed in the base material to light having a wavelength in the visible light range is different from that of the base material, and therefore light incident to the light diffuser plate 13 is diffusely transmitted. Examples of the base material of the light diffuser plate 13 may include glass and resin such as polyester-based resin, polycarbonate-based resin, polyacrylate-based resin, alicyclic polyolefin-based resin, polystyrene-based resin, polyvinyl chloride-based resin, polyvinyl acetate-based resin, polyether sulfonate-based resin, and triacetylcellulose-based resin. The light diffuser plate 13 also serves as a supporter for the optical member 17.

Optical Member

The optical member 17 includes lenticular lens sheets 14 and 15. The optical member 17 collects diffused light from the surface light source 16 and thus raises the front side brightness. Furthermore, it restrains side lobe light from being generated. The optical member 17 further controls the angular distribution of brightness in the two axial directions (vertical and horizontal directions).

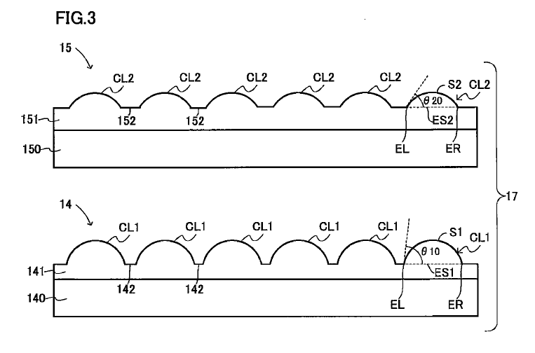

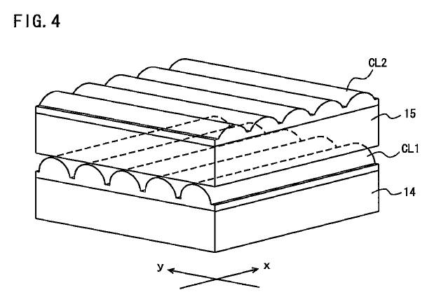

With reference FIG. 3, the lenticular lens sheet 14 as the lower layer of the optical member 17 has a plurality of cylindrical lenses CL1 arranged in parallel to one another. The lenticular lens sheet 15 as the upper layer of the optical member 17 has cylindrical lenses CL2 arranged in parallel to one another. Hereinafter, each of the cylindrical lenses CL1 and CL2 will also be generically referred to as “cylindrical lens CL.”

The lenticular lens sheet 14 includes a sheet or plate type base material portion 140 and a lens portion 141 formed on the base material portion 140.

The base material portion 140 is transparent to wavelengths in the visible light range. Examples of the base material portion 140 may include glass and resin such as polyester-based resin, polycarbonate-based resin, polyacrylate-based resin, alicyclic polyolefin-based resin, polystyrene-based resin, polyvinyl chloride-based resin, polyvinyl acetate-based resin, polyether sulfonate-based resin, and triacetylcellulose-based resin. The lens portion 141 has a plurality of cylindrical lenses CL1 arranged in parallel to one another. The lens part 141 is made of resin and the resin may be the same as or different from that of the base material part 140.

The lenticular lens sheet 15 similarly includes a base material portion 150 and a lens portion 151 having a plurality of cylindrical lenses CL2 arranged in parallel to one another.

As shown in FIG. 4, the cylindrical lenses CL1 of the lenticular lens sheet 14 as the lower layer are arranged in parallel in the vertical direction (y-direction) and the cylindrical lenses CL2 of the lenticular lens sheet 15 as the upper layer are arranged in parallel in the horizontal direction (x-direction). According to the embodiment, the shape of the lenticular lens sheets 14 and 15 are each a rectangular shape elongated in the horizontal direction, so that the cylindrical lenses CL1 are arranged in parallel in the shorter side direction and the cylindrical lenses CL2 are arranged in parallel in the longer side direction. In short, the arrangement direction of the cylindrical lenses CL1 is orthogonal to the arrangement direction of the cylindrical lenses CL2. In this way, the lenticular lens sheet 14 serves to control the viewing angle in the vertical direction (vertical viewing angle) and the lenticular lens sheet 15 serves to control the viewing angle in the horizontal direction (horizontal viewing angle).

Now, the function of the optical member 17 will be described.

Restraining Side Lobe Light

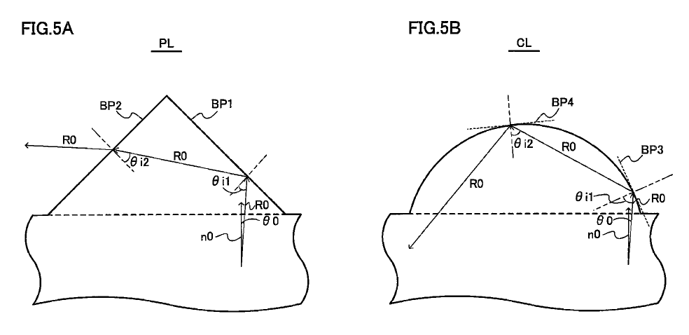

The optical member 17 restrains side lobes in the angular distribution of brightness by the cylindrical lenses CL. In FIG. 5A, part of an incoming light beam to a prism PL on the prism sheet 100 is totally reflected by one side plane BP1 of the prism PL and then transmitted through the other side plane BP2 to be externally emitted, which results in side lobe light. More specifically, a light beam R0 emitted in the direction at an angle θ0 from the normal line n0 to the outgoing surface of the surface light source 16 (the front surface of the backlight device) reaches the side plane BP1 of the prism PL. If the angle of incidence θi1 of the beam R0 is greater than the critical angle θc, the beam R0 is totally reflected. Then, when the beam R0 reaches the side plane BP2 of the prism PL, its angle of incidence θi2 sometimes becomes smaller than the critical angle θc. At the time, the light beam R0 is emitted outside the prism PL. The light beam R0 thus externally emitted is side lobe light that forms a wide angle with respect to the normal line n0 (front surface) and the light beam R0 forms side lobes in the angular distribution of brightness.

On the other hand, a cylindrical lens CL can restrain the side lobe light from being emitted. In FIG. 5B, a light beam R0 coming in at the same angle as that in FIG. 5A reaches the boundary plane BP3 on the convex surface of the cylindrical lens CL. If the angle of incidence θi1 of the light beam R0 is greater than the critical angle θc, the light beam R0 is totally reflected and reaches the boundary plane BP4 on the convex surface. The angle of incidence θi2 of the light beam R0 at the time is often greater than the critical angle θc. Therefore, the beam R0 is again totally reflected and returns to the surface light source 16. In short, with the cylindrical lens CL, a light beam totally reflected once is more often totally reflected again and returns to the surface light source than being transmitted and externally emitted. Therefore, a side lobe light beam can be restrained from being emitted, and side lobes in the angular distribution of brightness can be restrained.

As in the foregoing, the cylindrical lens CL restrains the side lobe light, so that the backlight device 10 can restrain side lobes from being generated.

Improvement of Front Side Brightness

Furthermore, in the optical member 17, the arrangement direction of the cylindrical lenses CL1 is orthogonal to the arrangement direction of the cylindrical lenses CL2, so that light can be more effectively collected to the front surface. This is because the lower layer cylindrical lenses CL1 collect light in the vertical direction, and the upper layer cylindrical lenses CL2 collect light in the horizontal direction. In this way, light is collected in the two axial directions, so that front side brightness higher than that provided by the prisms PL results.

Adjustment of Angular Distribution of Brightness in Two Axial Directions

In the optical member 17, the shapes of the cylindrical lenses CL1 and CL2 are different. In this way, the angular distribution of brightness in the horizontal and vertical directions can be adjusted to be different distributions, so that the horizontal viewing angle can be wider than the vertical viewing angle.

Referring back to FIG. 3, the angle θ10 (hereinafter referred to as “contact angle”) formed by the convex surface S1 of the cylindrical lens CL1 and the plane ES1 including both edges EL and ER of the lens CL1 (hereinafter as “edge planes”) is greater than the contact angle θ20 formed by the convex surface S2 of the cylindrical lens CL2 and the edge plane ES2 including both edges EL and ER of the cylindrical lens CL2. In this way, when the contact angle θ10 is set greater than the contact angle θ20, the horizontal viewing angle adjusted by the cylindrical lens CL2 can be wider than the vertical viewing angle adjusted by the cylindrical lens CL1. This will be described in detail in the following paragraphs.

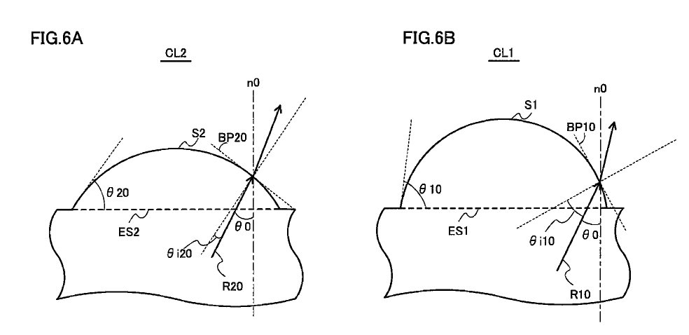

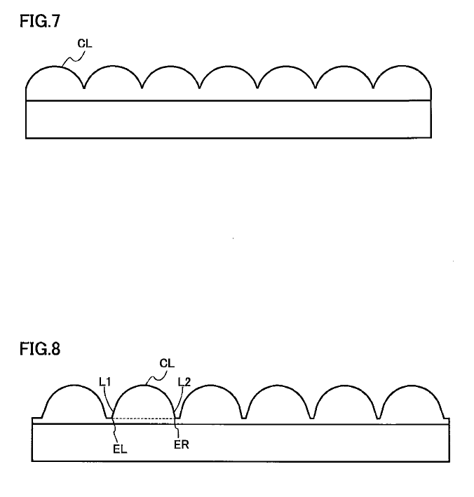

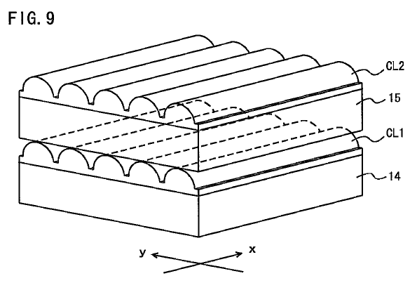

In FIGS. 6A and 6B, it is assumed that light beams R10 and R20 each emitted in a direction an angle of θ0 shifted from the normal line n0 come into the cylindrical lenses CL1 and CL2. When the light beams R10 and R20 reach the boundary planes BP10 and BP20 of the cylindrical lenses CL1 and CL2, the angle of incidence θi10 at the boundary plane BP10 is greater than the angle of incidence θi20 at the boundary plane BP20. This is because the inclination of the boundary plane BP10 with respect to the edge plane ES1 is greater than the inclination of the boundary plane BP20 with respect to the edge plane ES2. Therefore, the light beam R10 is emitted as it is refracted more in the direction of normal line n0 than the light beam R20.

In this way, the convex surface shape having a greater contact angle allows a greater angle of incidence for diffused light from the surface light source to be obtained. This is because the convex surface shape having a greater contact angle has more boundary planes having greater inclinations. More specifically, if the contact angle θ10 is greater than θ20, the percentage for the inclination of the boundary plane on the convex surface S1 with respect to the edge plane ES1 to be greater than the inclination of the boundary plane on the convex surface S2 with respect to the edge plane ES2 increases. Therefore, as the contact angle increases, the diffused light is more easily collected in the direction of the normal line n0 (front surface).

With the cylindrical lens CL, incoming diffused light is not entirely transmitted as shown in FIGS. 6A and 6B, but it is often the case that the light is repeatedly totally reflected and returned to the surface light source, reflected in the housing 11 and comes again into the cylindrical lens CL. Therefore, the path of the light beam in the cylindrical lens CL is not always as shown in FIGS. 6A and 6B, but the path of the light beam is considered mainly as shown in FIGS. 6A and 6B.

As in the foregoing, when the contact angle θ10 is set greater than θ20, a higher light collecting effect results for the cylindrical lens CL1 than for the cylindrical lens CL2. Therefore, the angular distribution of brightness in the vertical direction becomes narrower than that in the horizontal direction. As a result, the horizontal viewing angle becomes wider than the vertical viewing angle.

With the display device 1 such as a liquid crystal display, it is more often the case for the user to view the screen obliquely from the right or left than obliquely from above or below. The optical member 17 according to the embodiment has the cylindrical lenses CL1 arranged in parallel in the vertical direction and the cylindrical lenses CL2 arranged in parallel in the horizontal direction. Therefore, the horizontal viewing angle can be wider than the vertical viewing angle, so that the angular distribution of brightness can be adjusted suitably for the display device.

The contact angle θ10 is preferably set in the range from 60° to 90°. With such angle setting, the front side brightness can be improved and the contact angle θ20 can be adjusted in the range from 0° to 60°, so that the vertical and horizontal viewing angles can be set with improved flexibility.

Note that although the diffused light is collected more in the normal line direction to the surface light source 16 as the contact angle is greater, the inclination at the boundary plane on the convex surface is more likely to increase, which allows side lobe light to be more easily generated. If the inclination of the boundary plane increases on the whole, a light beam totally reflected by a certain boundary plane is more likely to be transmitted through another boundary plane rather than being totally reflected again. Therefore, when the cylindrical lenses CL1 and CL2 are compared, the cylindrical lens CL1 allows side lobe light to be more easily emitted. According to the embodiment, the cylindrical lens CL1 is arranged as the lower layer and the cylindrical lens CL2 as the upper layer. Therefore, if side lobe light is emitted at the cylindrical lens CL1, the cylindrical lens CL2 receives the side lobe light and again totally reflects or transmits it. As a result, the side lobe light generated at the cylindrical lens CL1 can be restrained from being directly emitted to the outside.

If only for the purpose of setting the horizontal viewing angle wider than the vertical viewing angle, the lenticular lens sheet 14 having the cylindrical lenses CL1 may be arranged as the upper layer and the lenticular lens sheet 15 having the cylindrical lenses CL2 may be arranged as the lower layer. However, if the cylindrical lenses CL1 are arranged as the upper layer, side lobe light is more easily emitted to the outside for the reason described above. Therefore, it is more preferable that the cylindrical lenses CL1 are arranged as the lower layer and the cylindrical lenses CL2 as the upper layer.

Note that the contact angle θ10 is greater than the contact angle θ20, and therefore the radius of curvature of the convex surface S1 is smaller than that of the convex surface S2 if the distance between the lens edges EL and ER is the same for the cylindrical lenses CL1 and CL2.

Referring back to FIG. 3, gaps 142 and 152 are provided between the cylindrical lenses CL. It is difficult to form cylindrical lenses CL with a large contact angle (such as 90°) adjacent to one another with no gap therebetween, while if the gaps are provided as shown in FIG. 3, the cylindrical lenses CL with a large contact angle can be arranged in parallel. Note that if the contact angle is small, the cylindrical lenses CL may be formed adjacent to one another with no gap therebetween as shown in FIG. 7.

The backlight device 10 according to the embodiment includes the optical member 17 including the lenticular lens sheet 14 as the lower layer and the lenticular lens sheet 15 as the upper layer, so that side lobe light can be restrained from being emitted and the front side brightness can be improved. The vertical and horizontal viewing angles can be adjusted and the horizontal viewing angle can be wider than the vertical viewing angle by setting the contact angle θ10 greater than the contact angle θ20.

The cross sectional shapes of the convex surfaces S1 and S2 of the cylindrical lenses CL1 and CL2 described above are each an arc having a single curvature, while as shown in FIG. 8, the vicinities of the edges EL and ER may be straight lines L1 and L2 in their cross sectional shapes, and still the advantage of the invention can be obtained. However, as the straight lines L1 and L2 are elongated, the shape approximates a prism shape, which allows side lobe light to be more easily generated.

The convex surfaces S1 and S2 of the cylindrical lenses CL1 and CL2 in their cross sectional shapes may be an elliptical arc instead of the circular arc.

According to the embodiment, the direction in which the cylindrical lenses CL1 are arranged is orthogonal to the direction in which the cylindrical lenses CL2 are arranged, but as shown in FIG. 9, they may be arranged in parallel to each other. In this case, the viewing angle is adjusted only in one axial direction (vertical or horizontal direction), but side lobe light can be reduced. The diffused light is collected toward the front surface direction by the cylindrical lenses CL1 as the lower layer and further collected toward the front surface direction by the cylindrical lenses CL2 as the upper layer, and therefore the front side brightness can be improved as compared to the prism sheet.

According to the embodiment, the surface light source 16 of the backlight device 10 is a direct type, but the surface light source 16 may be an edge light type.

The directions in which the cylindrical lenses CL1 and CL2 are arranged do not have to be strictly orthogonal to each other and need only cross in the range that allows light to be collected in two axial directions and the front side brightness to be improved. The front surface of the display device 1 and the optical member 17 have rectangular shapes elongated in the horizontal direction, while they may be other shapes.

### Example 1

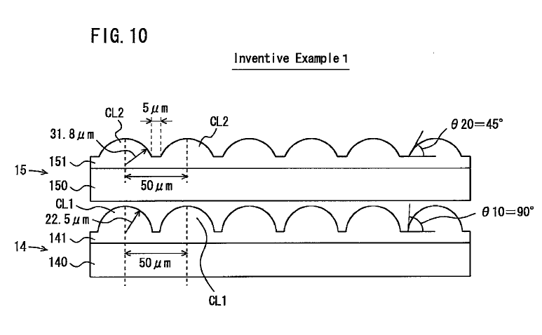

The optical member according to Inventive Example 1 shown in FIG. 10 and a prism sheet according to a comparative example were produced and examined for their angular distribution of brightness.

Manufacturing Method

A lenticular lens sheet 14 including the optical member according to Inventive Example 1 was produced by the following method. An ultraviolet curing resin layer 141 about as thick as 20 μm was formed on a polyethylene terephthalate (PET) film 140 as thick as 100 μm. The ultraviolet curing resin layer 141 was applied by a die coater. Then, the ultraviolet curing resin layer 141 was processed using a roll plate and the cylindrical lens CL1 was formed. More specifically, the roll plate having a groove with the same cross sectional shape as that of the cylindrical lens CL1 in the direction of the roll circumference was pressed against the resin and the resin was cured by ultraviolet irradiation. As shown in FIG. 10, the formed cylindrical lens CL1 had a pitch of 50 μm and a radius of curvature of 22.5 μm, the distance between the lens edges of the adjacent cylindrical lenses was 5 μm, and the contact angle θ10 was 90°.

The lenticular lens sheet 15 was produced in the same manner. An ultraviolet curing resin layer 151 about as thick as 15 μm was formed on a PET film 150 as thick as 100 μm and the cylindrical lenses CL2 were formed using a roll plate. As shown in FIG. 10, the pitch of the cylindrical lenses CL2 was 50 μm, the radius of curvature was 31.8 μm, the lens-edge distance of the cylindrical lens was 5 μm, and the contact angle θ20 was about 45°. The produced lenticular lens sheets 14 and 15 were placed on each other as shown in FIG. 4 to form the optical member according to Inventive Example 1.

The comparative prism sheet was produced by the following method. An ultraviolet curing resin layer as thick as 30 μm was formed on a PET sheet as thick as 100 μm using a die coater. Using a roll plate having a groove whose cross sectional shape is an isosceles triangular shape, a prism sheet having the shape as shown in FIG. 20 was produced. The pitch of the prisms was 50 μm and the vertical angle was 90°.

Examination of Angular Distribution of Brightness

The angular distribution of brightness was examined using the optical member produced according to Inventive Example 1 and the prism sheet according to the comparative example. The optical member is provided in a housing that stores cold cathode fluorescent lamps and has a reflection film provided inside and an optical diffuser plate fitted at its opening. At the time, the cylindrical lenses CL1 were arranged in parallel in the vertical direction and the cylindrical lenses CL2 were arranged in parallel in the horizontal direction.

After the optical member according to Inventive Example 1 was provided in the housing, the angular distribution of brightness was examined. As for the viewing angles, the normal line direction to the optical member (front surface) was set as a 0 degree axis, the inclination from the 0 degree axis in the vertical direction was the vertical viewing angle and the inclination from the 0 degree axis in the horizontal direction was the horizontal viewing angle. The brightness for each of the vertical and horizontal viewing angles was measured by a brightness photometer. The brightness was measured in the center of the screen (surface of the optical member).

Similarly, the prism sheet according to the comparative example was provided at the housing and the angular distribution of brightness was examined. At the time, the prisms were arranged in parallel in the vertical direction.

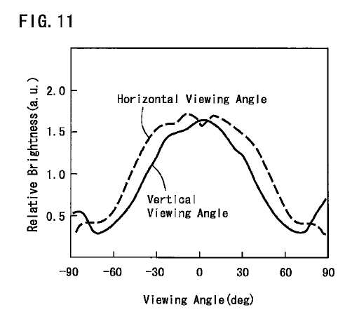

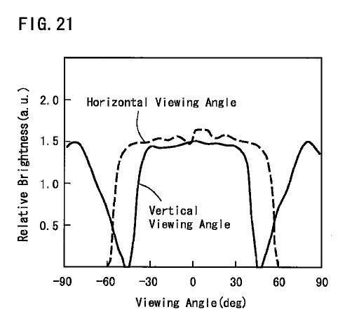

The angular distribution of brightness for the optical member according to Inventive Example 1 is shown in FIG. 11, and the angular distribution of brightness for the prism sheet according to the comparative example is shown in FIG. 21. The abscissas in FIGS. 11 and 21 represent viewing angles (deg), the ordinates represent relative brightness (a. u.) to the front side brightness of the optical diffuser plate (brightness in the normal line direction to the optical diffuser plate) in the housing as a reference (1.0). The solid line represents the angular distribution of brightness in the vertical viewing angle and the broken line represents the angular distribution of brightness in the horizontal viewing angle. With reference to FIGS. 11 and 21, side lobes were generated around viewing angles of −90° to −60° and 60° to 90° in the comparative example, but almost no side lobe was generated in Inventive Example 1. In Inventive Example 1, the vertical viewing angle and the horizontal viewing angle both have a distribution in which the relative brightness is peaked at a viewing angle of 0° and gradually decreases as the viewing angle increase, so that a natural light distribution resulted.

The relative brightness in the vicinity of the front surface (the range of a viewing angle of ±30°) in Inventive Example 1 exceeded 1.5, which was greater than that in the comparative example.

Furthermore, in the optical member according to Inventive Example 1, higher values resulted generally for the angular distribution of brightness for the horizontal viewing angle (broken line) than for the angular distribution of brightness for the vertical viewing angle (solid line). In short, the horizontal viewing angle was wider than the vertical viewing angle.

### Second Embodiment

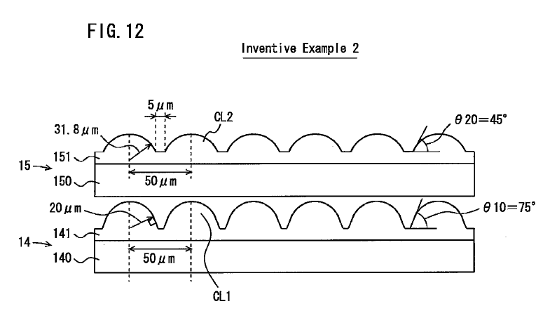

An optical member according to Inventive Example 2 having the shape shown in FIG. 12 was produced by the same method as that according to Inventive Example 1 and examined for the angular distribution of brightness in the same manner as the first embodiment.

An ultraviolet curing resin layer 141 as thick as 25 μm was formed on a PET film 140 as thick as 100 μm and a lenticular lens sheet 14 was formed using a roll plate. Similarly, an ultraviolet curing resin layer 151 as thick as 15 μm was formed on a PET film 150 as thick as 100 μm and a lenticular lens sheet 15 was formed using a roll plate. As shown in FIG. 12, the cross sectional shape of the cylindrical lens CL1 was an arc that has a radius of curvature of 20 μm at its top, and the line from the arc end point and the lens edge was the tangent at the arc end point. The contact angle θ10 was 75°. The lenticular lens sheet 15 had the same shape as that in FIG. 10.

The produced lenticular lens sheets 14 and 15 were placed on each other as shown in FIG. 4 and formed into the optical member according to Inventive Example 2.

The optical member according to Inventive Example 2 was provided on a housing as a surface light source. At the time, the cylindrical lenses CL1 were arranged in parallel in the vertical direction, while the cylindrical lenses CL2 were arranged in the horizontal direction. Then, similarly to the first embodiment, the angular distribution of brightness was examined.

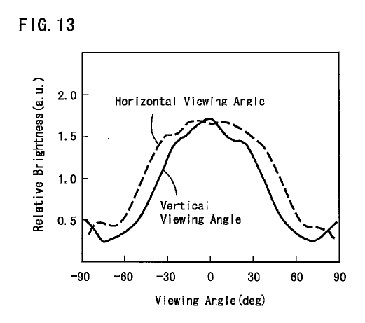

The examination result is given in FIG. 13. In comparison with FIG. 21, the side lobes according to Inventive Example 2 were much less than those in the comparative example. Both for the vertical and horizontal viewing angles, the brightness distribution was peaked at a viewing angle of 0°, so that a natural light distribution resulted.

The relative brightness in the vicinity of the front surface (at a viewing angle of ±30°) exceeded 1.5, which was higher than that in the comparative example. Furthermore, the horizontal viewing angle was wider than the vertical viewing angle.

### Third Embodiment

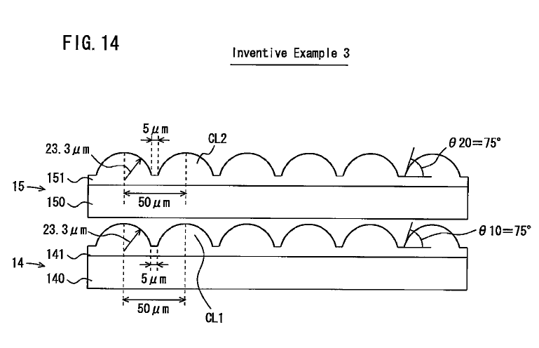

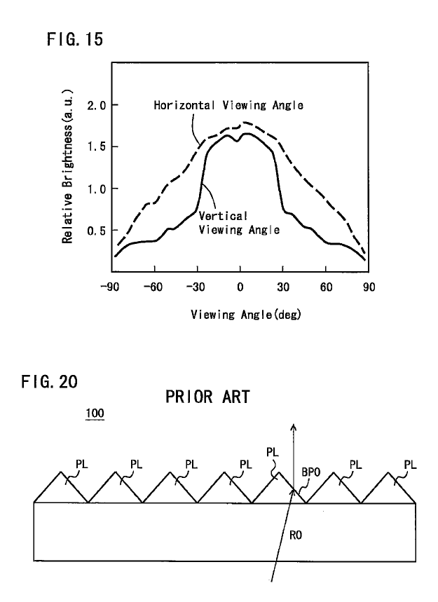

An optical member according to Inventive Example 3 having the shape shown in FIG. 14 was produced by the same method as that in the first embodiment and examined for the angular distribution of brightness.

Lenticular lens sheets 14 and 15 that form the optical member according to Inventive Example 3 were produced by the following method. Ultraviolet curing resin layers 141 and 151 as thick as 20 μm were formed on PET films 140 and 150 as thick as 100 μm, respectively. Then, the lenticular lens sheets 14 and 15 were produced using a roll plate. As shown in FIG. 14, the lenticular lens sheets 14 and 15 both had the same cross sectional shape. More specifically, the cylindrical lenses CL1 and CL2 both had a pitch of 50 μm, and a radius of curvature of 23.3 μM, and their contact angles θ10 and θ20 were both 75°. The interval between the cylindrical lenses CL was both 5 μm.

The produced lenticular lens sheets 14 and 15 were placed on each other as shown in FIG. 9 and thus formed into the optical member according to Inventive Example 3. The optical member was provided in the housing so that the cylindrical lenses CL1 and CL2 are both arranged in parallel in the vertical direction and then examined for the angular distribution of brightness.

The examination result is given in FIG. 15. In comparison with FIG. 21, side lobes in Inventive Example 3 were much less than those in the comparative example. The front side brightness was higher than that in the comparative example.

### Fourth Embodiment

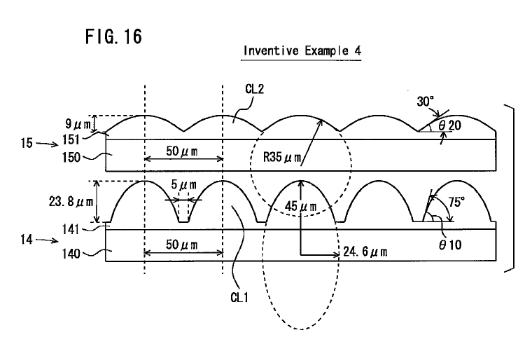

An optical member according to Inventive Example 4 having the shape shown in FIG. 16 was produced by the same method as that according to the first embodiment, and examined for the angular distribution of brightness.

Lenticular lens sheets 14 and 15 that form the optical member according to Inventive Example 4 were produced by the following method. Ultraviolet curing resin layers 141 and 151 as thick as 20 μm were formed on PET films 140 and 150 as thick as 100 μm, respectively. Then, the lenticular lens sheets 14 and 15 were produced using a roll plate. As shown in FIG. 16, the cross sectional shape of the cylindrical lens CL1 of the produced lenticular lens sheet 14 was an elliptical arc peaked at the ends of the major axis and the major axis size of the elliptical arc was 45 μm, the minor axis size was 24.6 μm, and the height of the cylindrical lens CL1 was 23.8 μm. The contact angle θ10 was 75°. The pitch of adjacent cylindrical lenses CL1 was 50 μm and the lens-edge distance was 5 μm.

The cross sectional shape of the cylindrical lens CL2 of the lenticular lens sheet 15 was an arc. More specifically, the shape was a circular arc and its top has a radius of curvature of 35 μm and a central angle of 60°. The line from the arc end point to the lens edge corresponds to the tangent at the arc end point, and the contact angle θ20 was 30°. The height of the cylindrical lens CL2 was 9 μm and the pitch was 50 μm.

The produced lenticular lens sheets 14 and 15 were placed on each other as shown in FIG. 4 and thus formed into the optical member according to Inventive Example 4.

The optical member according to Inventive Example 4 was provided on a housing as a surface light source. At the time, the cylindrical lenses CL1 were arranged in parallel in the vertical direction and the cylindrical lenses CL2 were arranged in parallel in the horizontal direction. Then, the angular distribution of brightness was examined similarly to the first embodiment.

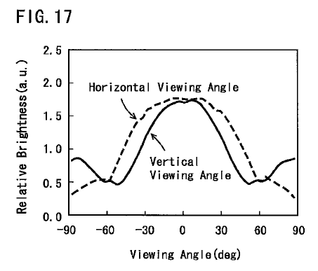

The examination result is given in FIG. 17. In comparison with FIG. 21, the side lobes in Inventive Example 4 were much less than those in the comparison example. The brightness distribution was peaked at a viewing angle of 0° for the vertical and horizontal viewing angles, so that a natural light distribution resulted. Furthermore, the relative brightness in the vicinity of the front surface (the range of an viewing angle of ±30°) according to Inventive Example 4 exceeded 1.5, which was higher than that in the comparative example. Furthermore, the horizontal viewing angle was wider than the vertical viewing angle.

### Fifth Embodiment

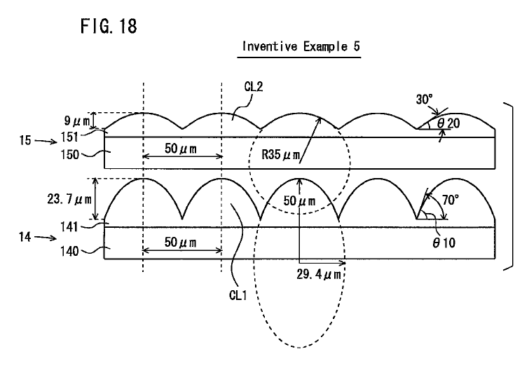

An optical member according to Inventive Example 5 in the shape shown in FIG. 18 was produced by the same method as that of the first embodiment and examined for the angular distribution of brightness.

Lenticular lens sheets 14 and 15 that form the optical member according to Inventive Example 5 were produced by the following method. Ultraviolet curing resin layers 141 and 151 as thick as 20 μm were formed on PET films 140 and 150 as thick as 100 μm, respectively. Then, the lenticular lens sheets 14 and 15 were produced using a roll plate. As shown in FIG. 18, the cross sectional shape of the cylindrical lens CL1 of the produced lenticular lens sheet 14 was an elliptical arc peaked at the ends of major axis and the major axis size of the elliptical arc was 50 μm, the minor axis size was 29.4 μm, and the height of the cylindrical lens CL1 was 23.7 μm. The contact angle θ10 was 70°. The pitch of adjacent cylindrical lenses CL1 was 50 μm. The shape and size of the cylindrical lens CL2 of the lenticular lens sheet 15 was the same as that of the cylindrical lens CL2 according to the fourth embodiment in FIG. 16.

The produced lenticular lens sheets 14 and 15 were placed on each other as shown in FIG. 4 and formed into the optical member according to Inventive Example 4.

The optical member according to Inventive Example 5 was provided on a housing as a surface light source. At the time, the cylindrical lenses CL1 were arranged in parallel in the vertical direction and the cylindrical lenses CL2 were arranged in parallel in the horizontal direction. Then, similarly to the first embodiment, the angular distribution of brightness was examined.

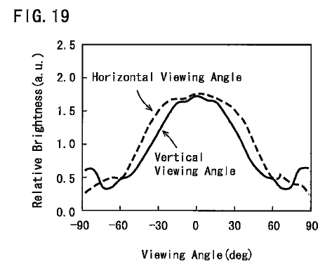

The examination result is given in FIG. 19. In comparison with FIG. 21, the side lobes in Inventive Example 5 were much less than those in the comparison example. The brightness distribution was peaked at a viewing angle of 0° for the vertical and horizontal viewing angles, so that a natural light distribution resulted. Furthermore, the relative brightness in the vicinity of the front surface (the range of an viewing angle of ±30°) according to Inventive Example 5 exceeded 1.5, which was higher than that in the comparative example. Furthermore, the horizontal viewing angle was wider than the vertical viewing angle.

Note that according to the above-described first to fifth embodiments, ultraviolet curing resin is applied on a PET film to form an ultraviolet curing resin film, and then the ultraviolet curing resin layer is cured by ultraviolet irradiation while a roll plate is pressed against the ultraviolet curing resin layer in order to produce a lenticular lens sheet, but the sheet may be produced by other methods. For example, after forming an ultraviolet curing resin layer by applying ultraviolet curing resin on a roll plate, a PET film may be pressed against the roll plate having the ultraviolet curing resin layer, and then the ultraviolet curing resin layer may be cured by ultraviolet irradiation in order to produce a lenticular lens sheet.

According to the above-described first to fifth embodiments, acrylate-based ultraviolet curing resin is used as ultraviolet curing resin.

Although the embodiments of the present invention have been described, the same is by way of illustration and example only and is not to be taken by way of limitation. The invention may be embodied in various modified forms without departing from the spirit and scope of the invention.

1. A backlight device, comprising:
a surface light source;
a first lenticular lens sheet provided on said surface light source and including a plurality of first cylindrical lenses arranged; and
a second lenticular lens sheet provided on said first lenticular lens sheet and including a plurality of second cylindrical lenses arranged.

2. The backlight device according to claim 1, wherein a direction in which said first cylindrical lenses are arranged crosses a direction in which said second cylindrical lenses are arranged.

3. The backlight device according to claim 2, wherein the direction in which said first cylindrical lenses are arranged is orthogonal to the direction in which said second cylindrical lenses are arranged.

4. The backlight device according to claim 2, wherein a first angle formed by a convex surface of said first cylindrical lens and a plane including both edges of said first cylindrical lens is different from a second angle formed by a convex surface of said second cylindrical lens and a plane including both edges of said second cylindrical lens.

5. The backlight device according to claim 4, wherein said first angle is greater than said second angle.

6. The backlight device according to claim 5, wherein said first angle is in the range from 60° to 90°.

7. The backlight device according to claim 1, wherein at least one of said first and second lenticular lens sheets has a gap between the cylindrical lenses arranged in parallel.

8. The backlight device according to claim 1, wherein said first and second lenticular lens sheets are in a rectangular shape,
said first cylindrical lenses are arranged along the shorter side direction of said first lenticular lens sheet, and said second cylindrical lenses are arranged along the longer side direction of said second lenticular lens sheet.

9. A display device comprising a backlight device including a surface light source, a first lenticular lens sheet provided on said surface light source and having a plurality of first cylindrical lenses arranged, and a second lenticular lens sheet provided on said first lenticular lens sheet and having a plurality of second cylindrical lenses arranged.

10. A display device comprising:
a backlight device including a surface light source, a first lenticular lens sheet provided on said surface light source and having a plurality of first cylindrical lenses arranged, and a second lenticular lens sheet provided on said first lenticular lens sheet and having a plurality of second cylindrical lenses arranged; and
a liquid crystal panel provided on said backlight device.

11. An optical member for use in a backlight device, comprising:
a first lenticular lens sheet provided on a surface light source in said backlight device and including a plurality of first cylindrical lenses arranged; and
a second lenticular lens sheet provided on said first lenticular lens sheet and including a plurality of second cylindrical lenses arranged.
